(19) United States
(12) Patent Application Publication
(10) Pub. No.: US 2006/0055762 A1
(43) Pub. Date: Mar. 16, 2006

(54) Ink-jet recording sheet

(75) Inventors: Masayuki Ushiku, Yokohama-shi (JP); Hisashi Mori, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/220,804

(22) Filed: Sep. 7, 2005

(30) Foreign Application Priority Data
Sep. 10, 2004 (JP) JP2004-263771

(51) Int. Cl. B41J 2/01

(52) U.S. Cl. 347/105

(57) ABSTRACT

An ink-jet recording sheet containing a support having thereon a porous ink receptive layer containing: a hydrophilic polymer; inorganic particles having an average diameter of not more than 100 nm, a nonionic surface active agent; and a cationic surface active agent.

This application is based on Japanese Patent Application No. 2004-263771 filed on Sep. 10, 2004, in Japanese Patent Office, the entire content of which is hereby incorporated by reference.

### TECHNICAL FIELD

The present invention relates to a porous ink-jet recording sheet which provides a high print density and a high glossiness as well as provides a high quality image without deterioration of bronzing due to precipitation of dye at the time of ink-jet recording.

### BACKGROUND

An ink-jet recording method in which recording is performed with water-based ink is well known, and in recent years, ink-jet recording has been making rapid improvement of image quality. In particular, in accordance with high image quality and high speed printing of recent years, an ink receptive layer has come to be required with high ink absorbability. An ink receptive layer is roughly classified into a swelling type, which is generally comprised of primarily a hydrophilic binder to retain ink by a swelling function of a hydrophilic binder, and a porous, in which inorganic micro-particles and a small amount of a hydrophilic binder constitutes a porous film, and the latter porous ink receptive layer is preferred with respect to high ink absorbability.

In ink-jet recording, generally, water-soluble dye is utilized as a coloring material; however, this water-soluble dye is highly hydrophilic so that dye is easily bled in the case of being stored for a long period under high humidity after ink-jet recording or water drops may adhering on the recorded surface. To solve this problem, dye mordant as a substance capable of fixing dye is generally added in an ink receptive layer, and substances provided with such dye fixing ability include such as inorganic micro-particles the surface of which is cationic (for example, alumina micro-particles) and cationic polymer which is provided with a primary to tertiary amino group or a quaternary ammonium group in the molecule.

Cationic polymer among them is preferably utilized because of a relatively high dye fixing capability. Further, dye mordant includes polyalkylene polyamine•dicyandiamide type condensates as described in such as Examined Japanese Patent Application Publication No. 2-3567 and JP-A No. 9-254529 (hereinafter, JP-A refers to Japanese Patent Publication Open to Public Inspection). Since dye mordant functions to improve water-resistance and depression of image bleeding after ink-jet recording in addition to providing a high print density, by the surface layer of an ink absorptive layer being mordanted by dye when having the higher dye fixing capability, dye mordant has been conventionally selected so as to be most suitable to dye species contained in ink.

Further, a polyvalent metal ion may be partly utilized in combination to enhance fixing of dye by cationic polymer, and specific methods are described in such as JP-A Nos. 60-67190 and 61-10484.

However, there is often caused a problem of precipitation of dye when strong fixing of dye is intended. Tendency of such aggregation of dye depends on types of cationic polymer, types of dye and combination thereof; however, dye aggregation may be caused by gradual proceeding of aggregation during long term storage even there is no problem immediately after printing.

When dye is precipitated, phenomena in which the printed surface becomes image-wise metallic (hereinafter, this phenomenon is called as bronzing) or becomes image-wise glossless. It is considered that the former phenomenon is caused when dye is provided with a high crystallization tendency, while the latter phenomenon is caused when dye is hard to become a crystalline state, however, either case significantly deteriorates print quality.

This problem tends to occur particularly in an ink-jet recording sheet provided with a porous ink receptive layer. The reason is not clear, however, it is estimated that, when a porous ink receptive layer is filled with ink, a dye fixing agent such as cationic polymer is liable to be relatively easily transferred, due to rare existence of hydrophilic binder in a void portion, and may diffuses near to the ink receptive layer surface, resulting in easier dye aggregation.

This problem may be further promoted when an inorganic cationic ion exists in an ink receptive layer, in particular, there is a problem of promoting dye aggregation in the presence of polyvalent metal compounds (such as magnesium, calcium, aluminum and zirconium compounds), which are effective to printing density, water-resistance and anti-bleeding. Further, it is known that an ink-jet recording sheet having high glossiness can be manufactured by coating a porous ink receptive layer on a water non-absorptive support such as polyethylene coated paper in which the both surfaces of raw paper are covered with polyethylene. However, it has been proved by the inventors' study that bronzing is easily caused in the case of employing such a water non-absorptive support. It is considered that since a water non-absorptive support is unable to absorb ink, ink has to be held only by an ink absorptive layer to fill the void layer with ink for relatively long period of time, resulting in easy generation of dye aggregation due to transfer of a dye fixing agent as estimated above.

On the other hand, in an ink absorptive layer, a method to utilize two types of surfactants has been proposed. For example, disclosed is an ink-jet recording sheet provided with an ink receptive layer containing a cationic type fluorine-containing surfactant and a nonionic type fluorine-containing surfactant together with polyvinyl acetal resin (for example, refer to patent literature 1). According to this method, it is said that an ink-jet recording sheet, having high transparency and being excellent in ink acceptance, water resistance, sharpness of recorded images and durability of the ink receptive layer, can be prepared, however, the constitution of an ink receptive layer is intended to be a swelling type, which is quite different from a porous ink-jet recording sheet proposed by this invention. Further, proposed is an ink-jet recording sheet characterized in that a dye receiving layer contains at least two types of surfactants which have made a eutectic mixture (for example, refer to patent literature 2). According to this method, it is said that an ink-jet recording sheet, which generates no repellency defects and exhibits an excellent appearance (the surface state), can be prepared, however, in patent literature, there are no specific descriptions on combination use of an nonionic surfactant and a cationic surfactant as defined in this invention, nor no descriptions or suggestions on a method to prepare a high quality images having high print density and gloss without deteriorating bronzing due to precipitation of dye at the time of ink-jet recording, which is an object of this invention.
[Patent Literature 1] JP-A No. 8-104055 (scope of claims)
[Patent Literature 2] JP-A No. 2004-50529 (scope of claims)

### SUMMARY

This invention has been made in view of the above problems, and an object of the invention is to provide an ink-jet recording sheet which exhibits high print density and gloss without deteriorating print quality by generation of bronzing due to dye aggregation.

The above object of this invention can be achieved by the following constitutions.

(1) An aspect of the present invention includes an ink-jet recording sheet comprising a support having thereon a porous ink receptive layer containing:
a hydrophilic polymer;
inorganic particles having an average diameter of not more than 100 nm, a nonionic surface active agent; and
a cationic surface active agent.

(2) Another aspect of the present invention includes an ink-jet recording sheet of the above-described item 1,
wherein the nonionic surface active agent exhibits a dynamic surface tension of not more than 60 mN/m at 20 milliseconds measured with a maximum bubble pressure method using an aqueous solution containing 0.3 weight % of the nonionic surface active agent.

(3) Another aspect of the present invention includes an ink-jet recording sheet of the above-described item 1,
wherein the nonionic surface active agent is acetylene glycol or a derivative of acetylene glycol.

(4) Another aspect of the present invention includes an ink-jet recording sheet of the above-described item 1,
wherein the cationic surface active agent contains a quaternary ammonium group in the molecule.

(5) Another aspect of the present invention includes an ink-jet recording sheet of the above-described item 1,
wherein the cationic surface active agent is lauryltrimethylammonium chloride.

(6) Another aspect of the present invention includes an ink-jet recording sheet of the above-described item 1,
wherein a ratio (C/N) is from 0.05 to 0.5, C being a weight of the cationic surface active agent and N being a weight of the nonionic surface active agent.

(7) Another aspect of the present invention includes an ink-jet recording sheet of the above-described item 1,
wherein the porous ink receptive layer contains a multivalent metal compound.

(8) Another aspect of the present invention includes an ink-jet recording sheet of the above-described item 1,
wherein the support is non-water-absorptive.

This invention can provide ink-jet recording sheet which exhibits high print density and gloss without deteriorating print quality by generation of bronzing due to dye aggregation.

### DESCRIPTION OF THE PREFERRED EMBODIMENTS

In the following, the most preferable embodiment to practice this invention will be detailed.

The inventors, as a result of extensive studies on the above problems, have found that an ink-jet recording sheet to provide high print density and gloss without deteriorating print quality by generation of bronzing due to dye aggregation can be realized by an ink-jet recording sheet characterized by being provided with an ink absorptive layer, which is comprised of at least inorganic micro-particles having a mean particle diameter of not more than 100 nm and hydrophilic polymer, and containing a nonionic surfactant and a cationic surfactant in said ink absorptive layer, which led to this invention.

That is, with respect to bronzing as a problem of this invention, incorporation of a nonionic surfactant in a porous ink absorptive layer, which is comprised of inorganic micro-particles having a mean particle diameter of not more than 100 nm and hydrophilic polymer, has been found effective to depress bronzing. However, it has been proved that a problem of decrease of print density in the case of a nonionic surfactant being contained.

As a result of an extensive study on this problem, it has been found that an ink-jet recording sheet further containing a cationic surfactant in a porous ink absorptive layer containing a nonionic surfactant enable to depress bronzing without decreasing print density and gloss.

No clear interpretation has been achieved with respect to improvement of bronzing without deterioration of print density and gloss by incorporation of a nonionic surfactant and a cationic surfactant, however, it is considered as follows. Since a nonionic surfactant is provided with a cloud point, transparency and gloss may be deteriorated due to decrease of solubility of a nonionic surfactant at the time of high temperature drying after coating of an ink absorptive layer. Thereafter, it is estimated that optical density of dye is decreased by optical scattering. It is considered that solubility of a nonionic surfactant is improved by utilizing a cationic surfactant in combination, resulting in depression of bronzing without deterioration of print density and gloss.

It has been also proved that still higher depression effect of bronzing can be obtained by utilizing a nonionic surfactant having a dynamic surface tension of not more than 60 mN/m, which is measured by a maximum bubble pressure method at 20 m·sec with respect to a 0.3% aqueous solution. With respect to this result, it is considered that dye aggregation becomes hard to be caused because of more rapid orientation of a surfactant on the dye surface at the stage of ink landing.

In the following, this invention will be detailed.

An ink-jet recording sheet of this invention is characterized by containing a nonionic surfactant and a cationic surfactant in an ink absorptive layer.

First, a nonionic surfactant will be explained.

A nonionic surfactant according to this invention is a surfactant provided with such as a hydroxyl group and an ether bond, which do not perform ionic dissociation in water, as a hydrophilic group and roughly classified into a polyethylene glycol type and a polyhydric alcohol type. Specific examples are described such as at pp. 89-126 of “New•Introduction to Surfactant” (Published by Sanyo Chemical Industry Co., Ltd.), including nonionic surfactants of polyoxyethylene alkylethers, polyoxyethylene alkylarylethers, acetylene glycols, polyoxyethylene•polypropylene block copolymers, and specific examples as nonionic surfactants include such as polyethylene glycol, polyoxyethylene laurylether, polyoxyethylene nonylether, polyoxyethylene cetylether, polyoxyethylene stearylether, polyoxyethylene oleylether, polyoxyethylene behenylether, polyoxyethylene polyoxypropylene cetylether, polyoxyethylene polyoxypropylene behenylether, polyoxyethylene nonylphenylether, polyoxyethylene octylphenylether, polyoxyethylene stearylamine, polyoxyethylene oleylamine, polyoxyethylene stearic acid amide, polyoxyethylene oleic acid amide, polyoxyethylene castor oil, polyoxyethylene abietylether, polyoxyethylene lanorineether, polyoxyethylene monolaurate, polyoxyethylene monostearate, polyoxyethylene glyceryl monooleate, polyoxyethylene glyceryl monostearate, polyoxyethylene propyleneglycol monostearate, oxyethylene oxypropyrene block polymer, a distyrenized phenol polyethylene oxide adduct, a tribenzylphenol polyethylene oxide adduct, an octylphenol polyoxyethylene polyoxypropylene adduct, glycerol monostearate, sorbitan monolaurate and polyoxyethylene sorbitan monolaurate.

A nonionic surfactant according to this invention is not specifically limited, however, it is preferable to utilize a surfactant having a dynamic surface tension of not more than 60 mN/m measured by a maximum bubble pressure method 20 m·sec on a 0.3% aqueous solution at with respect to more effective exhibition of the aimed effect of this invention.

A maximum bubble pressure method referred to in this invention is a procedure, in which a bubble is formed in a liquid and a surface tension is measured based on a pressure applied onto said bubble and a dynamic surface tension of a liquid can be measured by varying a bubble frequency, and is also called as a bubble pressure method.

Specifically, in the method, the interface between a liquid and an air is widened by swelling the bubble by blowing a nitrogen gas through a fine tube inserted into a liquid surface, resulting in determination of surface tension from a maximum pressure at that time.

When a radius of a spherical bubble is increased from R to R+dR, the increased portion ΔA of a surface area of the bubble is represented as follows:
ΔA=4π(R+dR)²−4πR²=8πR²dR

On the other hand, a work performed by pressure at this time is represented as follows because the sphere having an area of 4πR² is pushed to be moved by dR:
W=ΔP·4πR²dRW=ΔP·4πR²dR

Therefore, surface tension γ is determined as follows:
γ=W/ΔA (definition of surface tension)=ΔP·R/2

A specific interface tension meter by means of a maximum bubble pressure method includes, for example, Dynamic Surface Tension Meter BP-D4 Type manufactured by Kyowa Interface Science Co., Ltd. The dynamic surface tension of the present invention is measured at a liquid temperature of 35° C.

Nonionic surfactants exhibiting dynamic surface tension according to this invention are those having a high capability of lowering dynamic surface tension among general surfactants. Examples of surfactants having a high capability of lowering dynamic surface tension include such as polyoxyethylene alkylether, polyoxyethylene alkylphenylether and alkyltrimethylammonuium chloride provided with an alkyl group having a carbon chain of not more than 12, preferably an alkyl group having a carbon chain of 7-9 and more preferably an alkyl group having a branched structure, with respect to higher capability of lowering of dynamic surface tension.

In this invention, acetylene glycol or derivatives thereof is specifically preferable with respect to high capability of lowering of dynamic surface tension to provide a depression effect against bronzing as well as a gloss improvement effect.

Further, most of nonionic surfactants are provided with an ethylene oxide chain, and a viscosity of a coating solution is liable to be increased when the number of ethylene oxide per one molecule is over 10. With respect to handling in manufacturing, the number of ethylene oxide per one molecule is preferably not more than 10, more preferably not more than 8 and nonionic surfactants having no ethylene oxide chain are furthermore preferable.

The using amount of a nonionic surfactant according to this invention is not specifically limited, however, is preferably in a range of 0.05-2.5 g/m² with respect to achieving the effects of this invention. A amount a nonionic surfactant used in the present invention is more preferably in arrange of 0.1-1.0 g/m².

Next, a cationic surfactant will be explained.

Cationic surfactants utilized in this invention are classified roughly into two types, an amine salt type and a quaternary ammonium salt type, and specific structural examples are described, for example, at pp. 63-81 of “New/Introduction to Surfactants” (published by Sanyo Chemical Co., Ltd.).

Specifically, examples of an amine salt type include such as polyethylene alkylamine, N-alkylpropyrene amine, N-alkylpolyethylene polyamine, N-alkylpolyetylene polyamine dimethylsulfate, alkyl biguanide, long chain amine oxide, alkylimidazoline, 1-hydroxyethyl-2-alkylimidazoline, 1-acetylaminoethyl-2-alkylimidazoline and 2-alkyl-4-methyl-4-hydroxymethyloxazoline.

Further, examples of a quaternary ammonium salt type include such as long chain primary amine salt, alkyltrimethyl ammonium salt, dialkyldimethylethyl ammonium salt, alkyldimethyl ammonium salt, alkyldimethylbenzyl ammonium salt, alkylpyridinium salt, alkylquinilinium salt, alkylisoquinolinium salt, alkylpyridinium sulfate, atearamidomethylpyridnium salt, acylaminoehtyldiethylamine salt, acylaminoethylmethyldiethyl ammonium salt, alkylamidopropyldimethylbenzyl ammonium salt, fatty acid polyethylene polyamide, acylaminoethylpyridinium salt, acylaminoformylmethypyridinium salt, stearroxymethylpyridinium salt, fatty acid triethanolamine, fatty acid triethanolamine formate, trioxyethylene fatty acid triethanolamine, fatty acid dibutylaminoethanol, cetyloxymethylpyridinium salt and p-isooctylphenoxyethyoxyethyl dimethylbenzyl ammonium salt.

A cationic surfactant utilized in an ink absorptive layer according to this invention is not specifically limited; however, is preferably a cationic surfactant of a quaternary ammonium type and specifically preferably lauryltrimethyl ammonium chloride.

The using amount of a cationic surfactant according to this invention is not specifically limited, however, is preferably selected to be in a range of not less than 0.05 and not more than 0.5 as a weight ratio C/N of a cationic surfactant (C) to the aforesaid nonionic surfactant (N). When C/N is in this range, it is easy to achieve better print density and depression of bronzing, as well as high gloss.

It was found that appearance of crack can be restrained when a weight ratio C/N is controlled to fall within the above-described range. The reason of this restraining of crack formation is not fully explained. However, it is assumed as follows: A capillary pressure in a porous layer may be reduced by the presence of a surfactant during the drying stage of the coated layer. As a result, it is considered that compression stress is reduced and appearance of crack is prevented. In addition, when a cationic surfactant is added in such an amount to increase the solubility of a nonionic surfactant, the effect of surfactant will be increased. This also helps to prevent formation of crack.

As a measurement method of the content of a nonionic surfactant or a cationic surfactant in an ink absorptive layer, commonly known quantitative methods of surfactants can be applied, and measurement can be performed based on a method described in chapter 14 “Analysis of Surfactants” of “New Surfactants” (edited by Hiroshi Horiguchi, published by Sankyo Co., Ltd.); for example, as quantification of a cationic surfactant, applicable are Orange II Method, Disulphin Blue Method and Electric Conductivity Detection HPLC Method, and as qualification of a nonionic surfactant, applicable are such as Cobalt Thiocyanate Method and Alumina Column Method.

Next, an ink-jet recording sheet and constitution elements thereof will be explained.

An ink absorptive layer according to this invention contains at least inorganic micro-particles having a mean particle: diameter of not more than 100 nm and a hydrophilic binder in addition to each surfactant described above and is constituted of voids.

Inorganic micro-particles utilized in this invention include, for example, white inorganic pigment such as light calcium carbonate, heavy calcium carbonate, magnesium carbonate, kaolin, clay, talc, calcium sulfate, barium sulfate, titanium dioxide, zinc oxide, zinc hydroxide, zinc sulfate, zinc carbonate, hydrotalcite, aluminum silicate, diatomaceous earth, calcium silicate, magnesium silicate, synthetic amorphous silica, colloidal silica, alumina, colloidal alumina, pseudo böhmite, aluminum hydroxide, lithopone, zeolite and magnesium hydroxide. Inorganic micro-particles described above may be utilized as primary particles as they are or as a state of forming secondary particles.

In this invention, from a view point of obtaining a high quality print by an ink-jet recording sheet, inorganic micro-particles are preferably silica type particles or alumina type particles with respect to obtaining those having a mean particle diameter of not more than 100 nm at a relatively low cost, further preferably alumina, pseudo böhmite, colloidal silica or micro-particle silica synthesized by a gas phase method and specifically preferably micro-particle silica having a mean particle diameter of not more than 100 nm synthesized by a gas phase method.

The silica synthesized by a gas phase method may be those the surface of which is modified by aluminum. The aluminum content of gas phase method silica the surface of which is modified by aluminum is preferably 0.05-5% based on a weight ratio against silica.

A particle diameter of inorganic micro-particles described above is not more than 100 nm with respect to glossiness and coloring density and the under limit of the particle diameter is not specifically limited; however, is preferably not less than 10 nm with respect to manufacturing of inorganic micro-particles.

A mean particle diameter of inorganic micro-particles described above is determined by observing the cross-section or the surface of a porous ink absorptive layer through an electronmicroscope to measure particle diameters of arbitrary 100 particles and calculated as a simple averaged value (number average). Herein, an individual particle diameter is represented by a diameter of a supposed circle having an equivalent projection area.

Inorganic micro-particles described above may exist as primary particles or secondary to higher dimensional aggregated particles in a porous layer, however, a mean particle diameter described above means a particle diameter of those forming independent particles in an ink absorptive layer when being observed through an electronmicroscope.

In the case of the above-described inorganic micro-particles being secondary or higher aggregated particles, a mean primary particle diameter is smaller than a mean particle diameter observed in a porous film and a primary particle diameter of inorganic micro-particles is preferably not more than 30 nm and more preferably 4-20 nm.

A content of the above-described inorganic micro-particles in a water-soluble coating solution is 5-40 weight % and specifically preferably 7-30 weight %. The above-described inorganic micro-particles are necessary to have a sufficient ink absorbability and to form an ink absorptive layer having few cracks of the film and preferably make a coating amount of 5-50 g/m² in an ink receptive layer. And it is furthermore preferably 10-30 g/m².

A hydrophilic binder contained in an ink absorptive layer is not specifically limited and conventionally known hydrophilic binders can be utilized; for example, gelatin, polyvinyl pyrrolidone, polyethylene oxide, polyacrylamide and polyvinyl alcohol can be utilized, however, polyvinyl alcohol is preferred with respect to a relatively small moisture absorbing property of a binder and small curl of recording sheet as well as a high binding capability with a small using amount to provide few cracking and excellent film adhesion.

Polyvinyl alcohol utilized in this invention includes modified polyvinyl alcohol such as polyvinyl alcohol, the end of which is cationic modified, or anion modified polyvinyl alcohol provided with an anionic group, in addition to ordinary polyvinyl alcohol prepared by hydrolysis of polyvinyl acetate.

As polyvinyl alcohol prepared by hydrolysis of polyvinyl acetate, those having a mean polymerization degree of preferably not less than 300 and specifically preferably having a mean polymerization degree of 1,000-5,000 are utilized; the saponification degree is preferably 70-100% and specifically preferably 80-99.8%.

Cationic modified polyvinyl alcohol is, for example, as described in JP-A No. 61-10483, one provided with a primary to tertiary amino group or a quaternary amino group on the main chain or side chain of the above-described polyvinyl alcohol, and these can be prepared by hydrolysis of copolymer of an ethylenic unsaturated monomer, having a cationic group, and vinyl acetate.

Ethylenic unsaturated groups provided with a cationic group include such as trimethyl-(2-acrylamide-2,2-dimethylethyl)ammonium chloride, trimethyl-(3-acrylamide-3,3-dimethylpropyl)ammonium chloride, N-vinylimidazole, N-methylvinylimidazole, N-(3-dimethylaminopropyl)methacrylamide, hydroxyethyltrimethyl ammonium chloride and trimethyl-(3-methacrylamidopropyl)ammonium chloride.

The ratio of monomer containing a cationic modifying group of cationic modified polyvinyl alcohol is 0.1-10 mol % and preferably 0.2-5 mol %, against vinyl actate.

Anionic modified polyvinyl alcohol include, for example, polyvinyl alcohol provided with an anionic group described in JP-A No. 1-206088, copolymer of vinyl alcohol and vinyl compound provided with a water-soluble group described in JP-A Nos. 61-237681 and 63-307979, and modified vinyl alcohol provided with a water-soluble group described in JP-A No. 7-285265.

Further, nonionic modified polyvinyl alcohol includes, for example, polyvinyl alcohol derivatives in which an alkylene oxide group is added to a part of polyvinyl alcohol described in JP-A No. 7-9758, and block copolymer of a vinyl compound provided with a hydrophobic group and vinyl alcohol described in JP-A No. 8-25795.

At least two types of polyvinyl alcohol, which are different in such as a polymerization degree and a modification type, may be utilized in combination. In particular, in the case of utilizing polyvinyl alcohol having a polymerization degree of not less than 2000, it is preferable to add polyvinyl alcohol having a polymerization degree of not less than 2000 after 0.05-10 weight % and preferably 0.1-5 weight % of polyvinyl alcohol, against inorganic micro-particles, has been added in advance, so that significant viscosity increase is avoided.

Further, as a hydrophilic binder of an ink absorptive layer according to this invention, a polymer compound which cross-links or is polymerized by ionizing radiation is preferably utilized. A polymer compound which cross-links or is polymerized by ionizing radiation is water-soluble resin, which causes a reaction and performs a cross-linking or polymerizing reaction by irradiation of ionizing radiation such as ultraviolet rays or electron rays, and is water-soluble before the reaction, however, becomes essentially water-insoluble after the reaction. The above-described resin is provided with a hydrophilic property even after the reaction and retains sufficient affinity for ink.

Such resin is at least one type selected from a group constituted of saponification products of polyvinyl acetate, polyvinyl acetal, polyethylene oxide, polyalkylene oxide, polyvinyl pyrrolidone, polyacrylamide, hydroxyethyl cellulose, methyl cellulose, hydroxypropyl cellulose or derivatives of the above-described water-soluble resin and copolymer thereof, or the hydrophilic resin which is modified by a modifying group of such as a photo-dimerization type, a photodecomposition type, a photo-polymerization type, a photo-modification type and a photo-depolymerization type. Among them, resin modified with a modification group of a photo-dimerization type or a photo-modification type is preferred with respect to sensitivity or stability of resin itself. Modification groups of a photo-dimerization type are preferably those introduced with a diazo group, a cinnamoyl group, a styrylpyridinium group or a styrylquinolinium group, and preferably resin which can be dyed with water-soluble dye such as anionic dye after photo-dimerization. Such resin includes resin provided with a cationic group such as a primary to quaternary ammonium group, for example, photosensitive resin (compositions) described in such as JP-A Nos. 62-283339, 1-198615, 60-252341, 56-67309 and 60-129742; and resin which becomes cationic after curing like an azide group which becomes an amino group by curing, for example, photosensitive resin (compositions) described in JP-A No. 56-67309.

Specifically, for example, following compounds are listed; however, this invention is not limited to only these compounds.

Photosensitive resin described in JP-A No. 56-67309 is a resin composition which is provided with 2-azide-5-nitrophenylcarbonyloxyethylene structure represented by following formula (I) or 4-azide-3-nitrophenylcarbonyloxyethylene structure represented by following formula (II) in the polyvinyl alcohol structure.

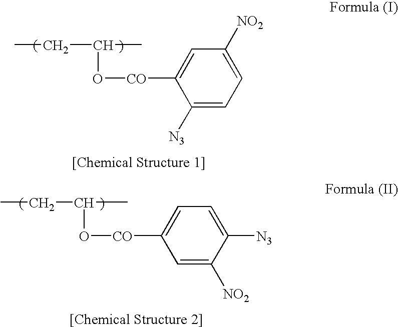

Specific examples of photosensitive resin are described in examples 1 and 2 of said patent publication and the constitutional components and the using amount thereof are described at p. 2 of said patent publication.

Further, in JP-A no. 60-129742, listed are resin compositions, which are provided with a structure of following formula (III) or (IV) in polyvinyl alcohol structure, as photosensitive resin.

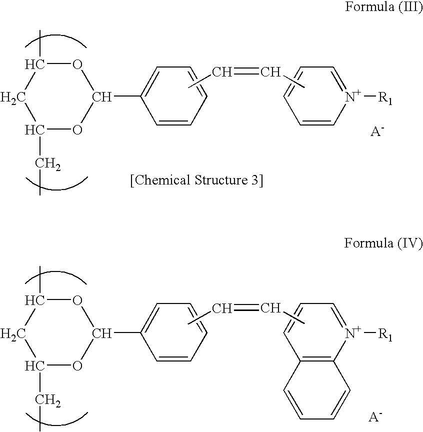

In this invention, among hydrophilic resin cross-linkable by ionization radiation, preferable are polyvinyl acetate saponification products provided with a constitutional unit represented by following general formula (A), for example, disclosed in JP-A 2000-181062, as a modification group of a photo-polymerization type, with respect to reactivity.

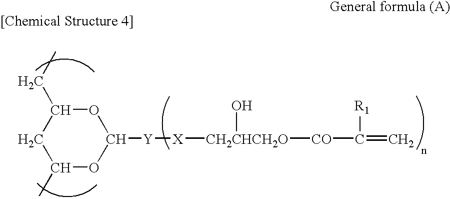

In above general formula (A), R₁ represents a hydrogen atom or a methyl group, Y represents an aromatic ring or a simple connecting hand, X represents —(CH₂)ₘ—COO—, —O—CH₂—COO— or —O—, m represents 0 or an integer of 1-6, and n represents 1 or 2.

In this invention, together with a hydrophilic binder containing a polymer compound polymerized by ionization radiation, a photo-initiator and a sensitizer are preferably incorporated. These compounds may be in a state of being dissolved or dispersed in a solvent, or chemically bonded against a hydrophilic binder including the above-described polymer compound.

Photo-initiators and photo-sensitizers employed are not specifically limited and conventionally well known photo-initiators and photo-sensitizers can be utilized, and include, for example, benzophenones (such as benzophenone, hydroxyl benzophenone, bis-N,N-dimethylamino benzophenone, bis-N,N-diethylamino benzophenone and 4-mthoxy-4′-dimethylamino benzophenone), thioxanthones (such as thioxanthone, 2,4-diethylthioxanthone, isopropylthioxanthone, chlorothioxanthone and isopropoxychloro thioxanthone), anthraquinoes (such as ethylanthraquinone, benzanthraquinone, aminoanthraquinone and chloroanthraquinone), acetophenones, benzoin ethers (such as benzoin methyl ether), 2,4,6-trihalomethyl triazines, 1-hydroxycyclohexyl phenyl ketone, 2-(o-chlorophenyl)-4,5-diphenylimidazole dimmer, 2-(o-chlorophenyl)-4,5-di(m-methoxyphenyl)imidazole dimmer, 2-(o-fluorophenyl)-4,5-diphenylimidazole dimmer, 2-(o-methoxyphenyl)-4,5-diphenylimidazole dimmer, 2-(p-methoxyphenyl)-4,5-diphenylimidazole dimmer, 2-di(p-methoxyphenyl)-5-phenylimidazole dimmer, 2-(2,4-dimethoxyphenyl)-4,5-diphenylimidazole dimmer, 2,4,5-triarylimidazole dimmer, benzyl methyl ketal, 2-benzyl-2-dimethylamino-1-(4-morpholinophenyl)-butane-1-one, 2-methyl-[4-(methylthio)phenyl]-2-morpholino-1-propane, 2-hydroxy-2-methyl-1-phenyl-propane-1-one, 1-[4-(2-hydroxyethoxy)phenyl]-2-hydroxy-2-methyl-1-propane-1-one, phenanthrenequinone, 9,10-phnanthrenequinone, benzoins such as methylbenzoin and ethylbenzoin, acridine derivatives (such as 9-phenylacridine and 1,7-bis(9,9′-acridinyl)heptane), bisacylphosphine oxide and mixtures thereof, and the above-described compounds may be utilized alone or in combination of at least two types.

Particularly, water-soluble photo-initiators such as 1-[4-(2-hydroxyethoxy)phenyl]-2-hydroxy-2-methyl-1-propane-1-one, 4-(2-hydroxyethoxy)phenyl-(2-hydroxy-2-propyl)ketone, thioxanthone ammonium salt and benzophenone ammonium salt are preferable also with respect to an excellent mixing capability as well as cross-linking efficiency.

An accelerator in addition to these initiators may be incorporated. The examples include such as p-dimethylamino ethylbenzoate, p-dimethylamino isoamylbenzoate, ethanolamine, diathanolamine and triethanolamine.

In such resin, mother nuclei polyvinyl alcohol resin is preferably provided with a polymerization degree of not less than 300 and more preferably not less than 1700. The modification ratio of an ionization radiation reactive modifying group against the segment is preferably not more than 4 mol % and more preferably not more than 1 mol %. When the polymerization degree of the segment is not more than 300 or the modification ratio is over 4 mol %, the cross-linking density of film is too high resulting in significant deterioration of a cracking property of a dried film. Simultaneously, in the case of too high cross-linking density, it is not preferable that a balance between moisture absorbability with a substrate and dimensional stability is deteriorated resulting in poor curling resistance.

In a manufacturing method of an ink-jet recording sheet of this invention, when the above-described polymer compound polymerized by ionization radiation is utilized as a hydrophilic binder, a coating solution containing a polymer compound polymerized by ionization radiation is coated and the coated layer is gelled by irradiation of ionization radiation at the time of the total solid content of the coated layer is 5-90%, followed by being dried. Ionization radiation referred in this invention include, for example, electron rays, ultraviolet rays, α rays, β rays, γ rays and X rays, however, electron rays or ultraviolet rays are preferred with respect to minimum danger to a human body and easy handling as well as the most prevailing industrial application.

An irradiation method of electron rays include, for example, a scanning mode, a curtain beam mode and a broad beam mode, however, a curtain beam mode is preferable with respect to processing capacity. The acceleration voltage of electron rays can be varied depending on specific density and film thickness of a coated film, however, is suitably 20-300 kV. The irradiation quantity of electron rays is preferably in a range of 0.1-20 Mrad.

As a light source of ultraviolet rays, such as a low pressure, a medium pressure and a high pressure mercury lamps and a metal halide lamp, which have an operation pressure of 100 Pa-1 MPa, are utilized, however, a high pressure mercury lamp and a metal halide lamp are preferable, and a metal halide lamp is more preferable, with respect to wavelength distribution of a light source.

In the case of ultraviolet rays of not longer than 300 nm being contained in the wavelength of a light source or the irradiation energy being over 100 J/cm², a mother nuclei of an ionization radiation cross-linking resin or coexisting various additives may cause decomposition not to achieve an effect of this invention, as well as there is a possibility of causing problems of odor due to decomposed products. On the contrary, the irradiation energy is less than 0.1 mJ/m², the cross-linking ratio is insufficient resulting in achieving insufficient effect of this invention. Therefore, a light source is preferably provided with a filter which cuts light of wavelengths not longer than 300 nm; the output power of a lamp is preferably 400 W-30 kW, and the radiation intensity is preferably 10 mW/cm²-10 kW/cm². In this invention, the irradiation energy is preferably 0.1 mJ/cm²-100 mJ/cm² and more preferably 1 mJ/cm²-50 mJ/cm².

The illuminance has a preferable range in the case of providing a same accumulated quantity of light (mJ/cm²), because transmittance of the light varies. The concentration distribution of a generated cross-linking reaction species differs depending on transmittance of ultraviolet rays, and a cross-linking reaction species is generated at a high concentration on the surface layer when ultraviolet ray illuminance is high resulting in a hard dense film formation on the surface layer of a coated film. While illuminance is too low, irradiation time to provide a necessary accumulation illuminance becomes too long to be disadvantageous with respect to introduction of facilities, as well as, it is not preferable that absolute quantity of light becomes insufficient due to scattering of ultraviolet rays by a coated film.

The ratio of inorganic micro-particles against a hydrophilic binder of an ink absorptive layer is preferably 2-20 based on a weight ratio. When the weight ratio is not less than 2 times, a porous layer having a sufficient void ratio can be obtained to easily provide a sufficient void volume, and a state of clogging of the void due to swelling of a hydrophilic binder at the time of ink-jet recording can be avoided, which will be a factor to maintain high ink absorptive rate. On the other hand, when the ratio is not more than 20, cracking is hardly caused at the time of an ink-jet absorptive layer being coated at a heavy thickness. The ratio of inorganic micro-particles against a hydrophilic binder is specifically preferably 2.5-12 times and most preferably 3-10 times.

In water-soluble coating solutions, which form an ink absorptive layer or other constituent layers according to this invention, also incorporated can be various types of additives. Such additives include, for example, organic latex micro-particles of such as cationic mordant, a polyvalent metal compound, polystyrene, polyacrylic acid esters, polymethacrylic acid esters, polyacrylamides, polyethylene, polypropyrene, polyvinyl chloride, polyvinylidene chloride, or copolymer thereof, urea resin or melamine resin; each surfactant of anionic, cationic, nonionic and amphoteric; ultraviolet absorbents described in JP-A Nos. 57-74193, 57-87988 and 62-261476; anti-fading agents described in such as JP-A Nos. 57-74192, 57-87989, 60-72785, 61-146591, 1-95091 and 3-13376; fluorescent whitening agents described in such as JP-A Nos. 59-42993, 59-52689, 62-280069, 61-242871 and 4-219266; pH controlling agents such as sulfuric acid, phosphoric acid, citric acid, sodium hydroxide, potassium hydroxide and potassium carbonate; a defoaming agent, an anticeptic agent, a viscosity increasing agent, an anti-static agent and a matting agent.

As cationic mordant, polymer mordant provided with primary to tertiary amino groups or a quaternary ammonium group may be utilized, however, polymer mordant provided with a quaternary ammonium group is preferable with respect to little color change and minimum deterioration of light fastness in long term storage. A preferable polymer mordant can be prepared as homo-polymer of monomer having a quaternary ammonium group, or as copolymer or condensation polymer thereof with other monomer.

In an ink-jet recording sheet of this invention, an ink absorptive layer specifically preferably contains a polyvalent metal compound.

Polyvalent metal compounds according to this invention include, for example, metal compounds of such as aluminum, calcium, magnesium, zinc, iron, strontium, barium, nickel, copper, scandium, gallium, indium, titanium, zirconium, tin and lead, and a polyvalent metal compound may be a polyvalent metal salt. Among them, compounds comprising magnesium, aluminum, zirconium, calcium and zinc are preferable with respect to being colorless; polyvalent metal compounds are more preferably compounds containing a zirconium atom, an aluminum atom or a magnesium atom; and polyvalent metal compounds are specifically preferably compounds containing a zirconium atom.

Compounds containing a zirconium atom, an aluminum atom or a magnesium atom which can be utilized in this invention (except zirconium oxide and aluminum oxide) may be water-soluble or water-insoluble as the compound itself, however, are preferably those which can be uniformly added in a desired position of an ink absorptive layer.

Further, compounds containing a zirconium atom, an aluminum atom or a magnesium atom which can be utilized in this invention may be any of single salt or double salt of inorganic acid or organic acid, an organometalic compound, or a metal complex, however, are preferably those which can be uniformly added in a desired position of an ink absorptive layer.

Specific example of compounds containing a zirconium atom, which can be utilized in this invention, include zirconium difluoride, zirconium trifluoride, zirconium tetrafluoride, hexafluoro zirconate (such as potassium salt), heptafluoro zirconate (such as sodium salt, potassium salt and ammonium salt), octafluoro zirconate (such as lithium salt), zirconium fluoride oxide, zirconium dichloride, zirconium trichloride, zirconium tetrachloride, hexachloro Zirconate (such as sodium salt and potassium salt), zirconium oxychloride (such as chloro zirconyl), zirconium dibromide, zirconium tribromide, zirconium tetrabromide, zirconium bromide oxide, zirconium triiodide, zirconium tetraiodide, zirconium peroxide, zirconium hydroxide, zirconium sulfide, zirconium sulfate, zirconium p-toluene sulfonate, zirconyl sulfate, sodium zirconyl sulfate, acid zirconyl sulfate tri-hydrate, potassium zirconium sulfate, zirconium selenate, zirconium nitrate, zirconyl nitrate, zirconium phosphate, zirconyl carbonate, zirconyl ammonium carbonate, zirconium acetate, zirconyl acetate, zirconyl ammonium acetate, zirconyl lactate, zirconyl citrate, zirconyl stearate, zirconium phosphate, zirconyl phosphate, zirconium oxalate, zirconium isopropylate, zirconium butylate, zirconium acetylacetonate, acetylacetone zirconium butylate, zirconium butylate stearate, zirconium acetate, bis(acetylacetonato)dichloro zirconium and tris(acetylacetonato)chloro zirconium.

Among these compounds containing a zirconium atom, preferable are zirconyl carbonate, zirconyl ammonium carbonate, zirconyl acetate, zirconyl nitrate, zirconium oxychloride, zirconyl lactate and zirconyl citrate, and specifically preferable are zirconium oxychloride, zirconyl ammonium carbonate and zirconyl acetate.

Specific example of compounds containing an aluminum atom, which can be utilized in this invention, include aluminum fluoride, hexafluoro aluminate (such as potassium salt), aluminum chloride, basic aluminum chloride (polyaluminum chloride), tetrachloro aluminate (such as sodium salt), aluminum bromide, tetrabromo aluminate (such as potassium salt), aluminum iodide, aluminate (such as sodium salt, potassium salt and calcium salt), aluminum chlorate, aluminum perchlorate, aluminum thiocyanate, aluminum sulfate, basic aluminum sulfate, potassium aluminum sulfate (alum), ammonium: aluminum sulfate (ammonium alum), sodium aluminum sulfate, aluminum phosphate, aluminum nitrate, aluminum hydrogen phosphate, aluminum carbonate, polyaluminum sulfate silicate, aluminum formate, aluminum acetate, aluminum lactate, aluminum oxalate, aluminum isopropylate, aluminum butylate, ethylacetate aluminum diisopropylate, aluminm tris(acetylacetonato), aluminum tris(ethylacetoacetate) and aluminum monoacetylacetonato bis(ethylacetonato). Among them, preferable are aluminum chloride, basic aluminum chloride, aluminum sulfate, basic aluminum sulfate and basic aluminum sulfate silicate.

Specific examples of a compound containing an magnesium atom, which can be utilized in this invention, include magnesium fluoride, magnesium acetate, magnesium bromide, magnesium chloride, magnesium formate, magnesium nitrate, magnesium sulfate, magnesium thiocyanate, magnesium thiosulfate, magnesium sulfide, magnesium carbide and magnesium phosphate, and among them, preferable are magnesium chloride, magnesium sulfate and magnesium nitrate.

Among these polyvalent metal compounds, specifically preferable are zirconium carbonate, zirconyl ammonium carbonate, zirconyl acetate, zirconyl nitrate, zirconium oxychloride, zirconyl lactate, zirconyl citrate, basic aluminum chloride, magnesium chloride, magnesium sulfate and basic aluminum sulfate silicate, among those exemplified as preferable compounds containing a zirconium atom, those exemplified as preferable compounds containing an aluminum atom and those exemplified as preferable compounds containing a magnesium atom, which are described above. Zirconium oxychloride, zirconyl ammonium chloride and zirconyl acetate are specifically preferable and zirconium oxychloride is most preferable.

The using amount of cationic polymer or a water-soluble polyvalent metal compound is preferably not more than 10 weight % and more preferably not more than 8 weight %, based on a weight ratio against inorganic micro-particles with respect to depressing deterioration of ink absorbability.

As an addition method of cationic polymer or a water-soluble polyvalent metal compound, in addition to a method in which the polymer or the compound is directly added in a coating solution and coated, a method, in which an aqueous solution of cationic resin or a water-soluble polyvalent metal compound is over-coated and dried, after recording sheet has been coated and dried, may be employed.

In an ink-jet recording sheet of this invention, a hardener of a water-soluble binder, which forms an ink absorptive layer, is preferably added.

Hardeners utilized in this invention are not specifically limited provided causing hardening reaction with a water-soluble binder; however, boric acid and salt thereof are preferred. In addition to these, those commonly known can be utilized, and compounds provided with a group reactive with a water-soluble binder or compounds which accelerate a reaction between different groups, with which a water-soluble binder is provided, each other are generally utilized by appropriate selection depending on the type of a water-soluble binder. Specific examples of a hardener include, epoxy type hardeners (such as diglycidyl ethyl ether, ethyleneglycol diglycidyl ether, 1,4-butanediol diglycidyl ether, 1,6-diglycidyl cyclohexane, N,N-diglycidyl-4-glycidyl oxyaniline, sorbitol polyglycidyl ether and glycelol polyglycidyl ether), aldehyde type hardeners (such as formaldehyde and glyoxal), active halogen type hardeners (such as 2,4-dichloro-4-hydroxy-1,3,5-s-triazine and bisvinylsulfonyl methyl ether) and aluminum alum.

Boric acid and salt thereof refers to an oxyacid having a boron atom as the center atom and salt thereof, and specifically include orthoboric acid, diboric acid, metaboric acid, tetraboric acid, pentaboric acid, octaboric acid, and salt thereof.

Boric acid and salt thereof as a hardener may be utilized as an independent aqueous solution or by mixing at least two types. Specifically preferable is a mixed solution of boric acid and borax. Aqueous solutions of boric acid and borax each can be prepared as a relatively dilute aqueous solution; however, a concentrated aqueous solution can be prepared by mixing the both to enable to prepare a concentrated coating solution. Further, it is advantageous that pH of an aqueous solution to be added can be relatively freely controlled. The total using amount of the above-described hardener is preferably 1-600 mg per 1 g of the above-described water-soluble binder.

In recording sheet of this invention, a viscosity of an ink absorptive layer coating solution is preferably set to 0.010-0.300 Pa·s and more preferably to 0.025-0.100 Pa·s at 40° C. When the viscosity of a coating solution becomes too high, supply of the coating solution to a coating apparatus becomes difficult resulting in poor coating solution supply.

As a support utilized in this invention, those well known as paper conventionally applied for an ink-jet recording sheet can be suitably utilized, and the support may be a water absorptive support, however, preferably a water non-absorptive support. In the case of using a water absorptive support, cockling may be caused due to absorption of water content in ink by a support, resulting in disturbed quality after printed.

As a water absorptive support utilizable in this invention include, for example, sheets and plates comprising ordinary paper, cloth and wood. As paper support, utilized can be those using wood pulp such as; chemical pulp such as LBKP and NBKP; machine pulp such as GP, CGP, RMP, TMP, CTMP, CMP and PGW; and used paper pulp such as DIP; as a primary raw material. Further, appropriately utilized can be various types of fiber form substances such as synthetic pulp, synthetic fiber and inorganic fiber, as a raw material. In the above-described paper support, various types of additives conventionally well known such as a sizing agent, pigment, a paper strength increasing agent, a fixer, a fluorescent whitening agent, a wet paper strengthening agent and a cationizing agent can be added. Paper support can be manufactured by mixing a fiber form substance such as wood pulp and various types of additives, described above, and by use of various types of paper making machines such as a long net paper making machine, a circular net paper making machine and a twin wire paper making machine. Further, size press treatment with such as starch or polyvinyl alcohol at the stage of paper making or on a paper making machine, a various coating treatment and calendar treatment may be performed.

A water non-absorptive support preferably utilized in this invention includes a transparent support and an opaque support. A transparent support includes, for example, films comprising a material such as polyester type resin, diacetate type resin, triacetate type resin, acryl type resin, polycarbonate type resin, polyvinyl chloride type resin, polyimide type resin, cellophane and celluloid; among them preferable are those provided with a property resisting against radiation heat when utilized in an over head projector (OHP) application, and polyethylene terephthalate is specifically preferred. A thickness of such a transparent support is preferably 50-200 μm, and as an opaque support, for example, resin coated paper in which polyolefin resin covering layer added with such as white pigment is provided at least on the one side of base paper (so-called RC paper), and so-called white PET, which is constituted of polyethylene terephthalate added with white pigment such as barium sulfate, are preferred. For the purpose of increasing adhesion strength between the aforesaid various supports and an ink absorptive layer, the support is preferably subjected to such a corona discharge treatment and a sub-coating treatment prior to coating of an ink absorptive layer. Further, an ink-jet recording sheet of this invention is not necessarily colorless, but may be a colored recording sheet. In an ink-jet recording sheet of this invention, a paper support, in which the both surfaces of a raw paper support are laminated with polyethylene, is specifically preferably utilized because recorded image exhibits near-photographic image quality as well as a high quality image can be obtained at low cost.

In the following, such paper support laminated with polyethylene will be explained.

Raw paper utilized in a paper support is primarily comprised of wood pulp and made into paper by being appropriately added with synthetic pulp such as polypropylene or synthetic fiber such as nylon and polyester. As wood pulp, any of LBKP, LBSP, NBKP, NBSP, LDP, NDP, LUKP and NUKP can be utilized; however, more amount of LBKP, NBSP, LBSP, NDP or LDP, which contains more short fiber, is preferably utilized. Herein, the ratio of LBSP or LDP is preferably 10-70 weight %. As the above-described pulp, chemical pulp (sulfate pulp and sulfite pulp), which contains few impurities, is preferably utilized, and pulp which has been subjected to a bleach treatment to improve whiteness is also useful. In raw paper, appropriately added can be a sizing agent such as higher fatty acid and alkyl ketene dimmer; white pigment such as calcium carbonate, talc and titanium oxide; a paper strength increasing agent such as starch, polyacrylamide and polyvinyl alcohol; a fluorescent whitening agent; a moisture retaining agent such as polyethylene glycol; a dispersant; and a softening agent such as quaternary ammonium. A drainage of pulp utilized in paper making is preferably 200-500 ml based on the definition of CFS, and a fiber length after beating is preferably 30-70% as a sum of a weight % of 24 mesh residue and a weight % of 42 mesh residue based on the definition of JIS-P-8207. A basis weight of raw paper is preferably 30-250 g and specifically preferably 50-200 g. A thickness of paper is preferably 40-250 μm. Raw paper may be subjected to a calendar treatment during or after the paper making to be provided with a high smoothness. A density of paper is generally 0.7-1.2 g/m² (JIS-P-8118). Further, a stiffness of raw paper is preferably 20-200 g based on the conditions defined in JIS-P-8143. A surface sizing agent may be coated on the surface of raw paper. A pH of raw paper is preferably 5-9 when being measured according to a hot water extraction method defined in JIS-P-8113. Polyethylene coated on the front and back surfaces of raw paper is primarily law density polyethylene (LDPE) and/or high density polyethylene (HDPE); however, others such as LLDPE and polypropylene can be also partly utilized. Particularly, a polyethylene layer of the ink absorptive layer side is preferably one, opacity and whiteness of which having been improved by addition of titanium oxide of a rutile or anatase type therein as commonly applied in photographic print paper. A content of titanium oxide is generally 3-20 weight % and preferably 4-13 weight % based on polyethylene. Polyethylene laminated paper can be utilized as glossy paper in this invention, and also as paper provided with a matt surface or a silk surface, similar to those prepared in ordinary photographic print paper, by a so-called embossing treatment when polyethylene is fusing extruded to be coated on a raw paper surface. A water content of paper in the above polyethylene laminated paper is preferably maintained at 3-10 weight %.

In an ink-jet recording sheet of this invention, a method to coat constituent layers such as an ink absorptive layer according to this invention can be appropriately selected from commonly known methods. In a preferable method, a coating solution constituting each layer is coated on a support and is dried. In this case, at least two layers can be also simultaneously coated. As a coating method, for example, preferably utilized can be a roll coating method, a rod-bar coating method, an air-knife coating method, a spray coating method, a curtain coating method or an extrusion coating method which employs a hopper described in U.S. Pat. No. 2,681,294.

Next, ink-jet ink (hereinafter, also simply referred to as ink) utilized for image printing on an ink-jet recording sheet of this invention will be explained.

As ink utilized for an ink-jet recording sheet of this invention, such as a water-based ink composition, an oil-based ink composition and a solid (phase transition) ink composition can be utilized, however, a water-based ink composition (for example, a water-based ink-jet recording liquid containing not less than 10 weight % of water based on the total amount of ink) can be specifically preferably utilized.

As a coloring agent for ink, utilized can be conventionally well known water-soluble dye such as acid dye, direct dye and reactive dye; or dispersion dye and pigment.

In a water-based ink composition, a water-soluble organic solvent is preferably utilized in combination. Water-soluble organic solvents utilizable in this invention include, for example, alcohols (such as methanol, ethanol, propanol, isopropanol, butanol, isobutanol, secondary butanol, tertiary butanol, pentanol, hexanol, cyclohexanol and benzyl alcohol), polyhydric alcohols (such as ethylene glycol, diethylene glycol, triethylene glycol, polyethylene glycol, propylene glycol, dipropylene glycol, polypropylene glycol, butylene glycol, hexanediol, pentanediol, glycerin, hexanetriol and thiodiglycol), polyhydric alcohol ethers (such as ethylene glycol monomethylether, ethylene glycol monoethylether, ethylene glycol monobutylether, diethylene glycol monomethylether, diethylene glycol monoethylether, diethylene glycol monobutylether, propylene glycol monomethylether, propylene glycol monobutylether, ethylene glycol monomethylether acetate, triethylene glycol monomethylether, triethylene glycol monoethylether, triethylene glycol monobutylether, ethylene glycol monophenylether and propylene glycol monophenylether), amines (such as ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyl diethyltriamine and tetramethyl propylenediamine), amides (such as formamide, N,N-dimethyl formamide and N,N-dimethylacetoamide) heterocyclic rings (such as 2-pyrrolidone, N-methyl-2-pyrrolidone, cyclohexyl pyrrolidone, 2-oxazolidone, 1,3-dimethyl-2-imidazolydinone), sulfoxides (such as dimethylsulfoxide), sulfones (such as sulpholane), urea, acetonitrile and acetone. Preferable water-soluble organic solvents include polyhydric alcohols. Further, combination use of polyhydric alcohol and polyhydric alcohol ether is specifically preferred. A water-soluble organic solvent may be utilized alone or in combination of plural types. An addition amount of a water-soluble organic solvent in ink is 5-60 weight % and preferably 10-35 weight % as the total amount.

In an ink composition utilized in this invention, incorporated can be by appropriate selection, depending on purposes of improving various characteristics such as ejection stability, adaptability to a printer head and an ink cartridge, storage stability, image storage stability and others, for example, a viscosity controlling agent, a surface tension controlling agent, a specific resistance controlling agent, a film forming agent, a dispersant, a surfactant, an UV absorbent, an antioxidant, an anti-fading agent, an antifungal agent and an anti-stain agent; which include organic latex micro-particles of such as polystyrene, polyacrylic acid asters, polymethacrylic acid esters, polyacrylamides, polyethylene, polypropylene, polyvinyl chloride, polyvinylidene chloride, copolymer thereof, urea resin or melamine resin; oil droplet micro-particles of such as fluid paraffin, dioctylphthalate, tricresyl phosphate and silicone oil; various types of surfactants of cationic or nonionic; UV absorbents described in JP-A Nos. 57-74193, 57-87988 and 62-261476; anti-fading agents described in such as JP-A Nos. 57-74192, 57-87989, 60-72785, 61-146591, 1-95091 and 3-13376; fluorescent whitening agents described in such as JP-A Nos. 59-42993, 59-52689, 62-280069, 61-242871 and 4-219266; pH adjusting agents such as sulfuric acid, phosphoric acid, citric acid, sodium hydroxide, potassium hydroxide and potassium carbonate.

An ink composition is provided with a viscosity at flying preferably of not more than 40 mPa·s and more preferably of not more than 30 mPa·s. Further, an ink composition is provided with a surface tension preferably of not less than 20 mN/m and more preferably of 30-45 mN/m.

An ink-jet head utilized in an ink-jet recording method employing an ink-jet recording sheet of this invention may be either an on-demand mode or a continuous mode. Further, as an ejection mode, listed as specific examples are such as an electrical-mechanical conversion mode (such as a single cavity type, a double cavity type, a vendor type, a piston type, a share mode type and shared wall type), an electrical-heat conversion mode (such as a thermal ink-jet type and a bubble jet type (registered trade mark)) and an electrostatic suction mode (such as an electrolysis control type and a slit jet type), however, any of ejection modes may be utilized.

### EXAMPLES

In the following, this invention will be concretely explained referring to examples, however, is not limited thereto. Herein, “%” described in examples represents weight % unless otherwise mentioned.

<Preparation of Recording Sheet>

[Preparation of Micro-Particle Dispersion A]

Gas phase method silica (product name: Aerosil 300, manufactured by Nippon Aerosil Co., Ltd., mean primary particle diameter of 7 nm) of 10 kg was suction dispersed, by use of Jet Stream Inductor Mixer, manufactured by Mitamura Riken Kogyo Co., Ltd., in an aqueous solution comprising 35 L of pure water added with 435 ml of ethanol, and the total volume was made up to 43.5 L with addition of pure water, resulting in preparation of a dispersion. This dispersion has a pH of 2.8 and contains 1 weight % of ethanol.

Next, into 400 ml of this dispersion, 40 ml of a 28% aqueous solution of cationic polymer (HP-1) were added and pre-dispersed by a Dissolver, and added was sodium acetate of necessary amount so as to adjust the pH to 4.5. Further, the resulting dispersion was dispersed by a sand mill homogenizer under a condition of a circumferential speed of 9 m/sec for 30 minutes. The total volume of this dispersion was made up to 540 ml to prepare almost transparent micro-particle dispersion A. This micro-particle dispersion A was filtered by us of a filter of TCP-10 type manufactured by Advantechs Toyo Co., Ltd.

(Preparation of UV Ray Polymerizing Polyvinyl Alcohol Aqueous Solution B-1)

After reacting p-(3-metacryloxy-2-hydroxypropyloxy)benzaldehyde with polyvinyl alcohol having a polymerization degree of 3000 and a saponification degree of 88%, based on the method described in JP-A No. 2000-181062, a photo-initiator (Kayacure QTX, manufactured by Nippon Kayaku Co., Ltd.) of 1.8% based on a weight ratio against polyvinyl alcohol was added, resulting in preparation of UV ray polymerizing polyvinyl alcohol aqueous solution B-1 having a cross-linking group modification ratio of 1 mol % and a solid content of 8 weight %.

[Preparation of Recording Sheet]

Into the above-prepared micro-particle dispersion A of 528 ml while being stirred at 40° C., 188 ml of UV ray polymerizing polyvinyl alcohol aqueous solution B-1 were gradually added, followed by being added with 50 ml of a 3% solution (water/isopropyl alcohol=1/1) of surfactant (S-1) as a nonionic surfactant and 10 ml of a 5% (water/isopropyl alcohol=1/1) solution of surfactant (S-5) as a cationic surfactant, and further the total solution was made up to 1000 ml with addition of pure water, resulting in preparation of translucent ink absorptive layer coating solution 1.

Next, on a polyethylene coated paper, in which the both sides of raw paper are covered with polyethylene, having a thickness of 170 g/m² (8% of anatase type titanium oxide is contained in polyethylene of the ink absorptive layer side, 0.05 g/m² of a gelatin sub-coating layer being provided similarly on the ink absorptive layer side, and a back layer of 0.2 g m² containing latex polymer having a Tg of approximately 80° C. is provided on the surface opposite to the ink absorptive layer), above-described ink absorptive layer coating solution 1 was coated by a bar coater at a wet layer thickness of 20 μm. Immediately after coating, the coated product was cooled in a cooling zone kept at 0° C. for 20 seconds, and was irradiated with UV rays at 100 mw/cm² so as to make an energy quantity of 30 mJ/cm², by use of a metal halide lamp having a primary wavelength at 365 nm equipped with a filter to cut wavelengths not longer than 300 nm, followed by being dried in a heated wind type oven at 80° C. After drying, an aqueous solution of poly basic aluminum (Takibine #1500, manufactured by Taki Chemical Co., Ltd.) was coated so as to make 0.4 g/m2 based on a converted aluminum weight by use of a bar coater, and further being dried in a heated wind type oven at 80° C. to prepare recording sheet 1. Herein, the contents of surfactant (S-1) and surfactant (S-5) in the aforesaid recording sheet are 0.3 g/m² and 0.1 g/m², respectively.

[Preparation of Recording Sheet 2-15]

Recording sheet 2-13 were prepared in a similar manner to preparation of recording sheet 1 described above, except that types and addition amounts of a nonionic surfactant and a cationic surfactant were changed as described in table 1. Further, recording sheet 14 and 15 were prepared in a similar manner to preparation of recording sheet 2 and 12, except that coating of polybasic aluminum (Takibine #1500, manufactured by Taki Chemical Co., Ltd.) was not performed.

The details of each surfactant described in table 1 are as follows.

Surfactant (S-1): nonionic surfactant, polyoxyethylene sorbitanetrioleate (Pionine D-945-T, dynamic surface tension=73.1 mN/m, manufactured by Takemoto Oil & Fat Co., Ltd.)

Surfactant (S-2): nonionic surfactant, polyoxyethylene octylphenylether (Octapole 100, dynamic surface tension=40.2 mN/m, manufactured by Sanyo Chemical Industry Co., Ltd.)

Surfactant (S-3): nonionic surfactant, acetylene glycol (Surfinol 82, dynamic surface tension=53.4 mN/m, manufactured by Nisshin Chemical Industry Co., Ltd.)

Surfactant (S-4): nonionic surfactant, acetylene glycol-ethylene oxide adduct (Surfinol 440, dynamic surface tension=37.4 mN/m, manufactured by Nisshin Chemical Industry Co., Ltd.)

Surfactant (S-5): cationic surfactant, lauryltrimethyl ammonium chloride (Coatamine 24P, manufactured by Kao Corp.)

Surfactant (S-6): cationic surfactant, oleylamine acetate (Pionine B-709, manufactured by Takemoto Oil & Fat Co., Ltd.)

Surfactant (S-7): cationic surfactant, lauryl pyridinium chloride (Pionine B-251, manufactured by Takemoto Oil & Fat Co., Ltd.)

Surfactant (S-8): cationic surfactant, perfluoroalkyltrimethyl ammonium salt (Megafax F-150, manufactured by Dainippon Ink & Chemicals Inc.)

Further, a dynamic surface tension of each nonionic surfactant described above and in table 1 is a value of a dynamic surface tension measured by means of a maximum bubble pressure method at 20 m·s by use of BP2 manufactured by Kruss Co., Ltd. (Germany) as a dynamic surface tension measuring apparatus when a 0.3 weight % aqueous solution of each nonionic surfactant is prepared and foams are continuously generated at a condition of a solution temperature of 35° C.

<Evaluation of Recording Sheet>

With respect to each recording sheet prepared above, each evaluation was performed according to the following method.

[Evaluation of Bronzing Resistance]

On each recording sheet prepared above, a black solid image was printed by use of Ink-jet Printer PMG800, manufactured by Seiko Epson Corp., and the printed sample was stored at 23° C. and a relative humidity of 80% for one week, followed by being visually observed to be evaluated based on the following criteria.

A: No generation of bronzing is observed.

B: Generation of weak bronzing is very partly observed.

C: Generation of bronzing is partly observed, however, it is not problematic quality in practical application.

D: Bronzing is vigorously generated, which is problematic quality in practical application.

E: Bronzing is very vigorously generated, which is not a quality to endure appreciation.

[Evaluation of Print Density]

On each recording sheet, a black solid image was printed at the maximum output power condition by use of the above-described printer, and the maximum reflection density of the printed image was measured with green light of X-Rite 938 (manufactured by X-Rite Co., Ltd.) to evaluate print density based on the following criteria.

A: The reflection density is not less than 2.2.

B: The reflection density is not less than 2.1 and less than 2.2.

C: The reflection density is not less than 2.0 and less than 2.1.

D: The reflection density is less than 2.0.

[Evaluation of Gloss]

A 60 degree gloss was measured on the ink absorptive layer surface side of each recording sheet by use of a variable degree gloss meter (VGS-1001DP), manufactured by Nippon Denshoku Kygyo Co., Ltd., and evaluation of gloss was performed based on the following criteria.

A: Glossiness is not less than 40%.

B: Glossiness is not less than 35% and less than 40%.

C: Glossiness is not less than 30% and less than 35%.

D: Glossiness is not less than 30%.

The results obtained in the above manner are summarized in table 1.

TABLE 1

| | Ink absorptive layer | | | | | | | | | | |
|---|---|---|---|---|---|---|---|---|---|---|---|
| | Nonionic surfactant | | | | | | | | | | |
| | (N) | | | | | | Polyvalent | | | | |
| | | Dynamic | | | | | metal | | | | |
| | | surface | | Cationic surfactant (C) | | | compound | Each evaluation | | | |
| Recording | | tension | Content | | Content | | (presence | Bronzing | Print | | |
| paper No. | Type | (mN/m) | (mg/m²) | Surfactant | (mg/m²) | C/N | or absence) | resistance | density | Gloss | Remarks |
| 1 | S-1 | 73.1 | 300 | S-5 | 100 | 0.33 | Yes | C | B | C | Inv. |
| 2 | S-2 | 40.2 | 300 | S-5 | 100 | 0.33 | Yes | A | B | B | Inv. |
| 3 | S-3 | 53.4 | 300 | S-5 | 100 | 0.33 | Yes | A | A | A | Inv. |
| 4 | S-4 | 37.4 | 300 | S-5 | 100 | 0.33 | Yes | A | A | A | Inv. |
| 5 | S-4 | 37.4 | 300 | S-6 | 100 | 0.33 | Yes | B | B | B | Inv. |
| 6 | S-4 | 37.4 | 300 | S-7 | 100 | 0.33 | Yes | B | B | B | Inv. |
| 7 | S-4 | 37.4 | 300 | S-5 | 150 | 0.50 | Yes | A | A | B | Inv. |
| 8 | S-4 | 37.4 | 300 | S-5 | 210 | 0.70 | Yes | B | B | C | Inv. |
| 9 | S-4 | 37.4 | 300 | S-5 | 18 | 0.06 | Yes | A | B | B | Inv. |
| 10 | S-4 | 37.4 | 300 | S-5 | 9 | 0.03 | Yes | B | C | B | Inv. |
| 11 | S-4 | 37.4 | 300 | S-8 | 100 | 0.33 | Yes | B | B | B | Inv. |
| 12 | — | — | — | — | — | — | Yes | E | C | C | Comp. |
| 13 | S-4 | 37.4 | 300 | — | — | — | Yes | B | D | C | Comp. |
| 14 | S-2 | 40.2 | 300 | S-5 | 100 | 0.33 | No | B | C | B | Inv. |
| 15 | — | — | — | — | — | — | No | D | C | C | Comp. |

Inv.: Invention,
Comp.: Comparison

It is clear from the results described in table 1 that recording sheet of this invention, which is provided with an ink absorptive layer defined by this invention containing a nonionic surfactant and a cationic surfactant, exhibits high print density and gloss without deteriorating print quality due to generation of bronzing, in contrast to comparative examples.

Further, recording sheet was prepared in a similar manner to preparation of each recording sheet described above, except that wet type silica having a mean particle diameter of 200 nm, which was prepared by gradually adding wet type silica on the market (product name: T-32, specific surface area of 202 g/m2, mean secondary particle diameter of 1.5 μm, precipitation silica, manufactured by Tokuyama Co., Ltd.) into a water-based medium, followed by being grinding dispersed while being rotated by a high speed rotary stirring homogenizer at a circumferential speed of 20 m/s, was utilized instead of gas phase method silica (product name: Aerosil 300, manufactured by Nippon Aerosil Co., Ltd., a mean particle diameter of primary particles of 7 nm) in an ink absorptive layer, and the similar evaluations were performed; the results were inferior to those described in table 1, and deterioration of gloss was generated resulting in unsatisfactory results.

What is claimed is:

1. An ink-jet recording sheet comprising a support having thereon a porous ink receptive layer containing:
a hydrophilic polymer;
inorganic particles having an average diameter of not more than 100 nm,
a nonionic surface active agent; and
a cationic surface active agent.

2. The ink-jet recording sheet of claim 1,
wherein the nonionic surface active agent exhibits a dynamic surface tension of not more than 60 mN/m at 20 milliseconds measured with a maximum bubble pressure method using an aqueous solution containing 0.3 weight % of the nonionic surface active agent.

3. The ink-jet recording sheet of claim 1,
wherein the nonionic surface active agent is acetylene glycol or a derivative of acetylene glycol.

4. The ink-jet recording sheet of claim 1,
wherein the cationic surface active agent contains a quaternary ammonium group in the molecule.

5. The ink-jet recording sheet of claim 1,
wherein the cationic surface active agent is lauryltrimethylammonium chloride.

6. The ink-jet recording sheet of claim 1,
wherein a ration (C/N) is from 0.05 to 0.5, C being a weight of the cationic surface active agent and N being a weight of the nonionic surface active agent.

7. The ink-jet recording sheet of claim 1,
wherein the porous ink receptive layer contains a multivalent metal compound.

8. The ink-jet recording sheet of claim 1,
wherein the support is non-water-absorptive.
